(19) United States
(12) Patent Application Publication
(10) Pub. No.: US 2013/0166283 A1
(43) Pub. Date: Jun. 27, 2013

(54) METHOD AND APPARATUS FOR GENERATING PHONEME RULE

(71) Applicant: KT Corporation, Seongnam (KR)

(72) Inventors: Young-Ho HAN, Yongin-si (KR); Jae-Han PARK, Seoul (KR); Dong-Hoon AHN, Seoul (KR); Chang-Sun RYU, Seoul (KR); Sung-Chan PARK, Seoul (KR)

(73) Assignee: KT CORPORATION, Seongnam (KR)

(21) Appl. No.: 13/727,128

(22) Filed: Dec. 26, 2012

(30) Foreign Application Priority Data
Dec. 23, 2011 (KR) 10-2011-0141604

(51) Int. Cl. G10L 15/28; G06F 17/27

(52) U.S. Cl. CPC G10L 15/28; G06F 17/274
USPC 704/9; 704/249

(57) ABSTRACT

A phoneme rule generating apparatus includes a spectrum analyzer configured to analyze pronunciation patterns of voices included in a plurality of voice data, a clusterer configured to cluster the plurality of voice data based on the analyzed pronunciation patterns, a voice group generator configured to generate voice groups from the clustered voice data, a phoneme rule generator configured to generate a phoneme rule corresponding to each respective voice group from among the generated voice groups and a group mapping DB configured to store the generated voice groups and the generated phoneme rules for an accurate voice recognition.

### CROSS-REFERENCE TO RELATED PATENT APPLICATION

This application claims the benefit of priority from the Korean Patent Application No. 10-2011-0141604, filed on Dec. 23, 2011 in the Korean Intellectual Property Office, the entire disclosure of which is incorporated herein by reference in its entirety.

### BACKGROUND

1. Field

Exemplary embodiments broadly relate to a method and an apparatus for generating a phoneme rule, and more specifically, exemplary embodiments relate to a method and an apparatus for recognizing a voice based on the generated phoneme rule.

2. Description of the Related Art

As a smart-phone has come into wide use, a voice interface has attracted great attention. The voice interface is a technique that enables a user to manipulate a device with voice customized to a particular user, and the voice interface is expected to be one of the most important interfaces now and in the future. Typically, a voice recognition technique uses two statistical modeling approaches including an acoustic model and a language model. The language model is made up of a headword as a target word to be recognized and phonemes for expressing real pronunciations made by people, and how accurate phonemes are generated is the key to the voice recognition technique.

In case of the voice recognition technique, a personal pronunciation is remarkably different depending on an education level or age and pronunciation can vary among different devices being used. By way of example, a word “LG” can be pronounced as [elji] or [eljwi]. Further, a user usually brings a smart-phone close to his/her mouth to say a word. Thus, for example, when the user says a word “BEXCO”, the user pronounces it as [becsko]. However, if the user says a word to a television with a distance of about 2 meters or more, the user tends to accurately pronounce it as [bec-ss-ko].

### SUMMARY

Accordingly, it is an aspect to provide a method and an apparatus for generating phoneme rules specific to various groups and for recognizing a voice based on the generated phoneme rule. However, the problems to be solved by the present disclosure are not limited to the above description and other problems may occur.

According to an aspect of exemplary embodiments, a phoneme rule generating apparatus includes a spectrum analyzer configured to analyze pronunciation patterns of a plurality of voice data, a clusterer configured to cluster the plurality of voice data based on the analyzed pronunciation patterns, a voice group generator configured to generate voice groups based on the clustered voice data, a phoneme rule generator configured to generate a phoneme rule corresponding to each respective voice group from among the generated voice groups.

According to another aspect of exemplary embodiments, a phoneme rule generating method includes analyzing pronunciation patterns of a plurality of voice data, clustering the plurality of voice data based on the analyzed pronunciation patterns, generating voice groups based on the clustered voice data, generating a phoneme rule corresponding to each respective voice group from among the generated voice groups.

According to yet another aspect of exemplary embodiments, a voice recognition apparatus includes a group identifier configured to receive a voice from a user device, and configured to identify a voice group of the received voice from among a plurality of voice groups, a phoneme rule identifier configured to identify a phoneme rule corresponding to the identified group from among a plurality of phoneme rules; and a voice recognizer configured to recognize the received voice based on the identified phoneme rule.

According to yet another aspect of exemplary embodiments, a voice recognition method includes receiving a voice from a user device, identifying a voice group of the received voice from among a plurality of voice groups, identifying a phoneme rule corresponding to the identified group from among a plurality of phoneme rules and recognizing the received voice based on the identified phoneme rule.

In exemplary embodiments, a method and an apparatus generates phoneme rules corresponding to each of the voice groups, which are generated based on the pronunciation patterns and, thus, it is possible to overcome inaccuracy of the voice recognition technique caused by differences in individual pronunciations and devices.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and in detail taken in conjunction with the accompanying drawings, in which:

FIG. 1 is a block diagram illustrating a phoneme rule generating apparatus according to an exemplary embodiment;

FIG. 2 is a table illustrating a phoneme rule index for various users and user devices according to an exemplary embodiment;

FIG. 3 is a block diagram illustrating a voice recognition apparatus according to an exemplary embodiment;

FIG. 4 is a flow chart illustrating a voice recognition method according to an exemplary embodiment; and

FIG. 5a is a view illustrating voice recognition results according to a related art technique.

FIG. 5b is a view illustrating voice recognition results according to an exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote analogous parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

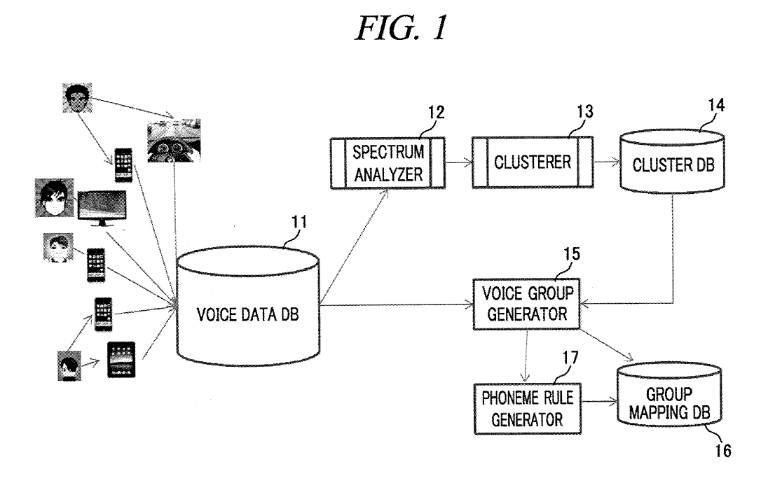

FIG. 1 is a block diagram illustrating a phoneme rule generating apparatus according to an exemplary embodiment. According to FIG. 1, a phoneme rule generating apparatus 100 includes a voice data database 11, a spectrum analyzer 12, a clusterer 13, a cluster database 14, a voice grouping generator 15, a group mapping DB 16, and a phoneme rule generator 17. The phoneme rule generating apparatus illustrated in FIG. 1 is provided by way of an example, and FIG. 1 does not limit the phoneme rule generating apparatus.

The voice data DB 11 stores multiple voice data including voices of multiple users. As illustrated in FIG. 1, the voice data DB 11 may collect voices using multiple user devices and using many people that utilize these various user devices. The collected voices are then stored them. That is, the multiple voice data may include information about the user devices that transmit voices. By way of example, the voice data DB 11 may include a hard disc drive, a ROM (Read Only Memory), a RAM (Random Access Memory), a flash memory, and a memory card.

The spectrum analyzer 12 analyzes pronunciation patterns of voices included in the multiple voice data from the voice data DB 11. That is, the spectrum analyzer 12 analyzes an acoustic feature of a voice. The acoustic feature of the voice can be similar to a pronunciation pattern. The clusterer 13 clusters the multiple voice data based on the analyzed pronunciation patterns, and stores the clustered voice data in the cluster DB 14. By way of example, the cluster DB 14 may include a hard disc drive, a ROM (Read Only Memory), a RAM (Random Access Memory), a flash memory, and a memory card.

The voice group generator 15 generates voice groups from the clustered voice data stored in the cluster DB 14. That is, the voice group generator 15 uses clustered voice data to find phoneme rules according to the pronunciation patterns. By way of example, the voice group generator 15 finds a rule that ┌a first group generally pronounces an English word “LG” as [elji] instead of [eljwi].┘

The phoneme rule generator 17 finds and generates each phoneme rule corresponding to each voice group generated by the voice group generator 15.

The group mapping DB 16 stores the voice groups generated by the voice group generator 15 and the phoneme rules generated by the phoneme rule generator 17 in a related manner. In other words, the group mapping DB 16 stores the respective phoneme rules linked to the respective groups. As described above by way of an example, the voice data includes the information of the user devices that transmit voices, and, thus, each voice group stored in the group mapping DB 16 includes a phoneme rule index corresponding to the users and user devices. By way of example, the group mapping DB 16 may include a hard disc drive, a ROM (Read Only Memory), a RAM (Random Access Memory), a flash memory, and a memory card. The phoneme rule generating apparatus includes at least a memory and a processor.

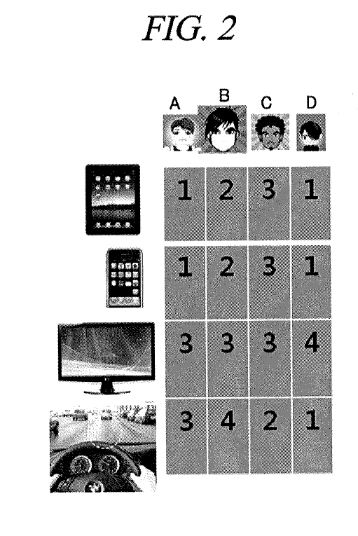

FIG. 2 is a table illustrating a phoneme rule index corresponding to users and user devices according to an exemplary embodiment. The phoneme rule index illustrated in FIG. 2 is provided by way of an example only, and FIG. 2 does not limit the form of grouped data.

As illustrated in FIG. 2, users A, B, C, and D are mapped with various devices, i.e. a tablet PC, a mobile phone, a TV, and a navigation device, and phoneme rule indexes are marked on each user by user devices. By way of example, when a user A uses a tablet PC, a phoneme rule index “1” is marked, and when the user A uses a TV, a phoneme rule index “3” is marked. That is, a pronunciation pattern of the same user can be recognized differently depending on a type of a device being used.

Therefore, the exemplary embodiment is needed to build a voice interface of a N screen service that enables a user to collectively use services, which are individually used by various devices including such as a TV, a PC, a tablet PC and a smart-phone, in a user- or content-centric manner. This is because a current voice interface uses different applications depending on a type of a terminal but is processed by an engine located at a server and the same principle applies to various terminals. As the number of recognized vocabulary words increases, the number of computations geometrically increases. A method of recomposing phonemes for each of multiple devices is needed to increase efficiency and accuracy of the voice interface system.

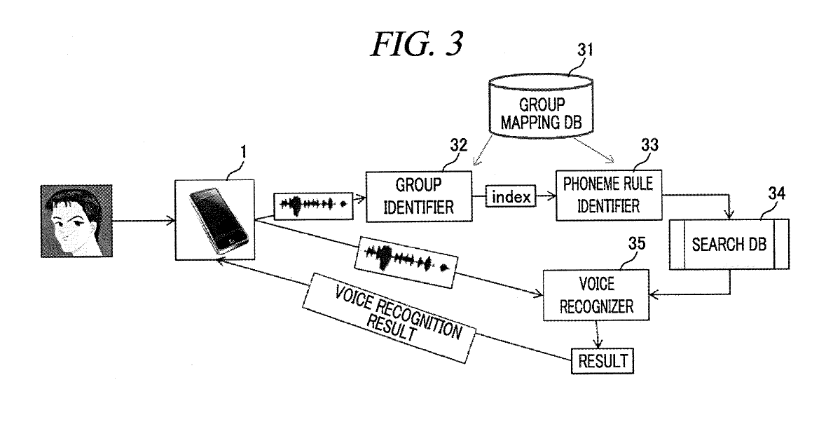

FIG. 3 is a block diagram illustrating a voice recognition apparatus according to an exemplary embodiment. According to FIG. 3, a voice recognition apparatus includes a group mapping database 31, a voice group identifier 32, a phoneme rule identifier 33, a search database 34, and a voice recognizer 35. The voice recognition apparatus illustrated in FIG. 3 is provided by way of an example, and FIG. 3 does not limit the voice recognition apparatus.

Respective components of FIG. 3 which form the voice recognition apparatus are generally connected via a network. The network is an interconnected structure of nodes, such as terminals and servers, and allows sharing of information among the nodes. By way of an example, the network may include, but is not limited to, the Internet, a LAN (Local Area Network), a wireless LAN (Wireless Local Area Network), a WAN (Wide Area Network), and a PAN (Personal Area Network). The voice recognition apparatus includes at least a memory and a processor.

The group mapping database 31 stores voice groups and phoneme rules received from phoneme rule generating apparatus. That is, the voice recognition apparatus may include the phoneme rule generating apparatus.

The voice group identifier 32 receives a voice from a user device and identifies a voice group corresponding to the received voice by using the group mapping database 31.

The phoneme rule identifier 33 identify a phoneme rule corresponding to the identified group by using the group mapping database 31 and stores the identified group in the search database 34. By way of example, the search database 34 may include a hard disc drive, a ROM (Read Only Memory), a RAM (Random Access Memory), a flash memory, and a memory card.

The voice recognizer 35 recognizes the voice received from a user device 1 based on the identified phoneme rule stored in the search database 34, and transmits a result thereof to the user device 1.

As described above, according to an exemplary embodiment, the user device 1 may include various types of devices. By way of example, the user device 1 may include a TV apparatus, a computer, a navigation device or a mobile terminal which can access a remote server via a network. Herein, the TV apparatus may include a smart TV and an IPTV set-top box, the computer may include a notebook computer, a desktop computer, and a laptop computer which are equipped with a web browser, and the mobile terminal may include all types of hand-held based wireless communication devices, such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), a Wibro (Wireless Broadband Internet) terminal, and a smart-phone, with guaranteed portability and mobility.

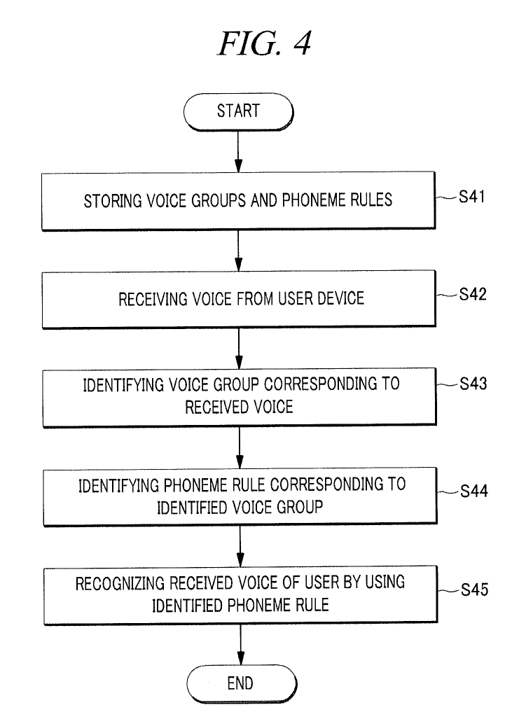

FIG. 4 is a flow chart illustrating a voice recognition method according to an exemplary embodiment. The voice recognition method illustrated in FIG. 4 includes operation that may be processed in time-series by the phoneme rule generating apparatus and the voice recognition apparatus according to exemplary embodiment illustrated in FIGS. 1 to 3. Therefore, although not described below, the descriptions regarding the phoneme rule generating apparatus and the voice recognition apparatus of FIGS. 1-3 can be applied to the voice recognition method according to an exemplary embodiment illustrated in FIG. 4.

In operation S41, the voice recognition apparatus stores voice groups and phoneme rules received from the phoneme rule generating apparatus. As described above, by way of an example, in case that the voice recognition apparatus includes the phoneme rule generating apparatus, the phoneme rule generating apparatus stores voice groups and phoneme rules by analyzing pronunciation patterns of voices included in a plurality of voice data stored in a voice database, and clustering the plurality of voice data based on the analyzed pronunciation patterns, and generating voice groups from the clustered voice data, and generating each phoneme rule corresponding to each voice group.

In operation S42, the voice recognition apparatus receives a voice from a user device.

In operation S43, the voice recognition apparatus identifies a voice group corresponding to the received voice. More specifically, the voice recognition apparatus extracts a user's voice that is transmitted from the user device 1, and determines the best match for the received voice from among the voice groups. Specifically, a voice group is determined that best matches the received voice, and a phoneme rule index corresponding to the voice group is extracted from the group mapping database 31. That is, if the user transmits his/her voice by using a voice recognition application, the voice is transmitted to the voice group identifier 32 and the voice recognizer 35. The voice group identifier 32 determines which voice group of the group mapping DB 31 includes the received voice and transmits the phoneme rule index to the phoneme rule identifier 33.

In operation S44, the voice recognition apparatus identifies a phoneme rule which corresponds to the identified group. The identified phoneme rule corresponds to the extracted phoneme rule index. Further, the voice recognition apparatus may update the search DB 34 by using the identified phoneme rule in operation S45.

In operation S45, the voice recognition apparatus recognizes the received voice based on the identified phoneme rule.

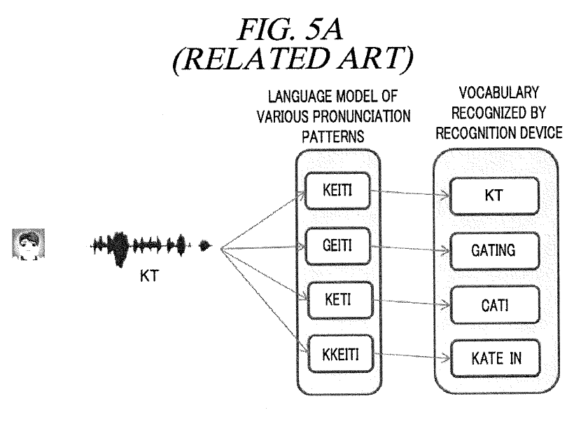

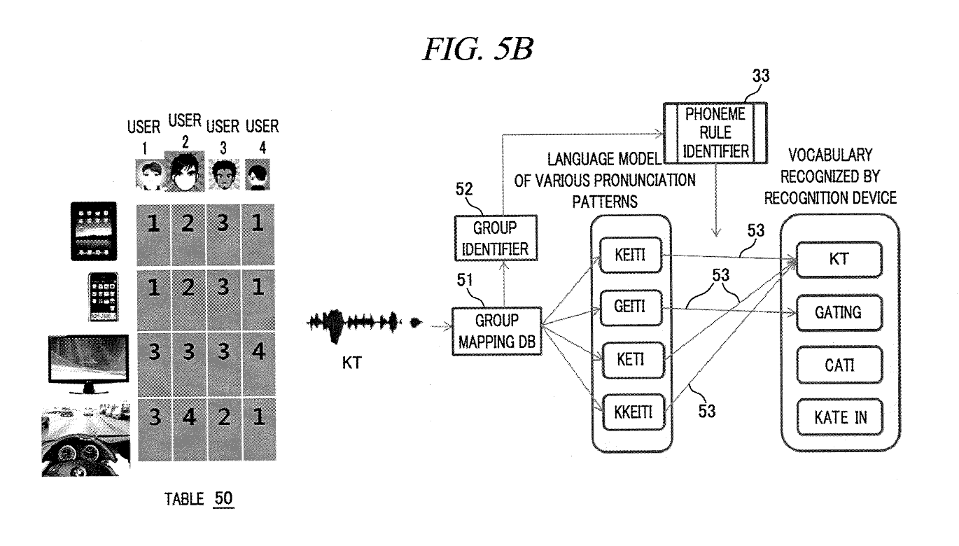

FIGS. 5a and 5b are views that provide an example of a voice recognition method according to an exemplary embodiment.

FIG. 5a is a view illustrating voice recognition results according to a related art and FIG. 5b is a view illustrating voice recognition results according to an exemplary embodiment.

According to FIG. 5a, according to a related art, a speech waveform of “KT” input into a recognition device is compared with phonemes such as [keiti], [geiti], [keti], and [kkeiti]. Each pronunciation is mapped with a particular word such that the speech waveform is mapped with a particular phoneme and then with a particular vocabulary word. In this case, it is impossible to know information of personal pronunciation or information of a device used, and, thus, “KT” can be wrongly recognized as “CATI” or “GETTING.” By way of example, when a user says “KT”, the user may pronounce [i] of [kei] too short as if he/she pronounces [ke] or due to the nature of a device used, the user may be needed to pronounce the word loudly and clearly and may pronounce it as [kkeiti]. In this case, the word “KT” can be wrongly recognized as “CATI” and “GETTING”, respectively.

Meanwhile, according to the exemplary embodiment as illustrated in FIG. 5b, it is possible to know a personal pronunciation pattern and a user device used, so that there is sufficient data to more accurately match the spoken word to a particular vocabulary word. If pronunciation patterns can be grouped, as shown in a table 50, the grouped information can be transmitted to the voice recognizer 35 together with the input voice(s). Therefore, the voice recognition apparatus can select phonemes to be suitable for a particular group using the phoneme rule identifier 33 by using the indexes provided in the table.

By way of example, even if the word “KT” is pronounced as [keti] or [kkeiti], “KT” can be correctly recognized by using the grouping index information. Specifically, using the table 50 stored in a group mapping database 51, a particular group is identified by the group identifier 52. Based on the identified group, a corresponding phoneme rule 53 is selected using phoneme rule identifier 33. For example, if a group is identified as a tablet of user 1, the corresponding phoneme rule may suggest that KEITI, KETI, or KKETI all mean KT and so on. In an exemplary embodiment, a phoneme rule customized to a particular pronunciation and/or a particular device is applied, as opposed to general rules, resulting in a more accurate recognition. Based on a device type, considerations such as distance from the microphone of the device, audio interface of the device, and so on may be accounted for. In an exemplary embodiment, the phoneme rule may be customized to a particular user or users e.g., users' individual pronunciations may be used to generate a phoneme rule.

An exemplary embodiment can be embodied in a storage medium including instruction codes executable by a computer such as a program module executed by the computer. Besides, the data structure according to the exemplary embodiment can be stored in the storage medium executable by the computer. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes a certain information transmission medium.

The above description of exemplary embodiments is provided for the purpose of illustration, and it would be understood by those skilled in the art that various changes and modifications may be made without changing technical conception and essential features of the present disclosure. Thus, it is clear that the above-described exemplary embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather and their equivalents than by the detailed description of exemplary embodiments. It shall be understood that all modifications and embodiments conceived from the meaning and scope of the claims and their equivalents are included in the scope of the present disclosure.

What is claimed is:

1. A phoneme rule generating apparatus comprising:
a spectrum analyzer configured to analyze pronunciation patterns of a plurality of voice data;
a clusterer configured to cluster the plurality of voice data based on the analyzed pronunciation patterns;
a voice group generator configured to generate voice groups based on the clustered voice data;
a phoneme rule generator configured to generate a phoneme rule corresponding to each respective voice group from among the generated voice groups.

2. The apparatus of claim 1, wherein the plurality of voice data comprises voices and information about respective user devices that transmitted the voices.

3. The apparatus of claim 2, wherein the plurality of voice data is clustered based on the information about the respective user devices.

4. A phoneme rule generating method comprising:
analyzing pronunciation patterns of a plurality of voice data;
clustering the plurality of voice data based on the analyzed pronunciation patterns;
generating voice groups based on the clustered voice data;
generating a phoneme rule corresponding to each respective voice group from among the generated voice groups.

5. The method of claim 4, wherein the plurality of voice data comprises voices and information about respective user devices that transmitted the voices.

6. The method of claim 5, wherein the plurality of voice data is clustered based on the information about the respective user devices.

7. A voice recognition apparatus comprising:
a group identifier configured to receive a voice from a user device, and configured to identify a voice group of the received voice from among a plurality of voice groups;
a phoneme rule identifier configured to identify a phoneme rule corresponding to the identified group from among a plurality of phoneme rules; and
a voice recognizer configured to recognize the received voice based on the identified phoneme rule.

8. A voice recognition method comprising:
receiving a voice from a user device;
identifying a voice group of the received voice from among a plurality of voice groups;
identifying a phoneme rule corresponding to the identified group from among a plurality of phoneme rules; and
recognizing the received voice based on the identified phoneme rule.

9. The apparatus of claim 1, wherein the clustering is based on a particular user and a device type from a plurality of device types.

10. The apparatus of claim 1, wherein the phoneme rule is specific to the respective voice group from among a plurality of voice groups which are categorized by at least one of device type which receives the voice data and a particular user which speaks the voice data.

11. The apparatus of claim 1, further comprising a group mapping DB configured to store the generated voice groups and the generated phoneme rules.

12. The apparatus of claim 1, wherein the generated phoneme rule that corresponds to a respective voice group in which an input voice is classified, is applied in voice recognition of the input voice.

13. The method of claim 4, further comprising storing the generated voice groups and the generated phoneme rules.

14. The voice recognition apparatus of claim 7, further comprising a group mapping DB configured to store the plurality of voice groups and the plurality of phoneme rules.

15. The voice recognition apparatus of claim 7, wherein each of the plurality of phoneme rules correspond to a respective one of the plurality of voice groups.

16. The voice recognition apparatus of claim 7, wherein the group identifier is configured to further receive a type of the user device and an identifier which links the received voice to a particular user and wherein the voice group is identified based on at least one of the type of the user device and the identifier of the user.

17. The method of claim 8, further comprising storing voice groups and phoneme rules.
